(19) United States
(12) Patent Application Publication
(10) Pub. No.: US 2007/0062561 A1
(43) Pub. Date: Mar. 22, 2007

(54) Method And Apparatus For Testing Particulate Contamination In Wafer Carriers

(75) Inventors: Robert T. Koch, Port Ewen, NY (US); Somer D. Mayer, Wappingers Falls, NY (US); Brian Stevens, Monticello, NY (US); Dean J. Tomasi, Poughkeepsie, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/162,658

(22) Filed: Sep. 19, 2005

(51) Int. Cl. B08B 3/04

(52) U.S. Cl. 134/18; 134/26; 134/34; 134/25.4

(57) ABSTRACT

Wafer carriers in an integrated circuit fab are tested for residual particle contamination by replacing the standard carrier door by a test cover having a gas inlet and outlet, counting the number of FM particles exiting the carrier during a flush cycle with a test gas having a known concentration of FM particles and either continuing processing if the number of FM particles is below a threshold, performing a purge with the test gas if the contamination is in a purge range, or sending the carrier out for cleaning if the number of FM particles is above the purge range.

### TECHNICAL FIELD

The field of the invention is that of integrated circuit processing, in particular reduction of defects on a wafer by particles deposited on the wafer in the course of handling and transporting the wafers.

### BACKGROUND OF THE INVENTION

Contamination of an integrated circuit from particles deposited on the wafer during processing has always been a problem in the field of integrated circuit fabrication.

The limits on particulate contamination permitted in a clean room have been tightened with each generation of wafer size to an industry standard of 100 particles per cubic meter (@ 0.5 μm) in fabs using 200 mm wafers.

With the advent of 300 mm wafers, the increased number of chips per wafer and the associated reduction in linewidth has required further reduction in permitted contamination levels. In addition, advanced technologies warrant larger die size, thus fewer particles can impact the same percentage of chips, causing an ever increasing challenge to maintain yields. Identifying every source of contamination is critical to maximizing product yields.

Current practice in clean rooms is that the wafers are never exposed to the ambient air flow, but remain enclosed within cassettes as they are transported from one processing machine to the next. With this change, the relevant contamination is that within the cassette.

The wafers are transported in a standard container, referred to as a Front Opening Unified Pod (FOUP) that has a removable door that is closed during transport from one machine to another and is removed by a mechanism (the robot handler) after the FOUP engages the standard interface on the machine.

At present, the tools in a fab, both process tools and measurement tools, have an associated FM (foreign matter) qualification and an associated limit on the number of particles that may be added to a wafer by the tool, or during the period that the wafer spends in the tool. These limits are so tight that the difference between a pass and a fail for a particular tool may be only a few particles, e.g. variations of particles by 5-10 particles per cubic meter (@ 0.16 μm) can cause a process tool to be shut down.

With such tight limits, the residual contamination within a FOUP becomes a significant factor affecting the yield.

Residual contamination will never be eliminated and comes from many sources, including the operations of moving the wafers in and out, removing the door, etc.

When a FOUP has become excessively contaminated, it is sent out of the fab for a thorough (and expensive) cleaning process.

Those skilled in the art will appreciate that the increased number of chips per wafer in the 300 mm wafers means that the effect of a contaminated FOUP will impact more chips than in the previous 200 mm wafers. Further, an undetected contaminated FOUP will continue to contaminate wafers until it is detected.

At present, there is not a consensus among fabs on the best way or the proper interval to measure contamination within FOUPs.

One approach is to swap the product at regular intervals into a FOUP that hasn't been pre-inspected, only cleaned and returned to the line. With several swaps during the processing of an entire wafer, the likelihood of encountering a contaminated FOUP is appreciable.

The art could benefit from a systematic approach to detecting FOUP contamination in a tradeoff between the cost in time and process interruption to perform the detection and the effect of undetected contamination.

### SUMMARY OF THE INVENTION

The invention relates to a method of detecting contamination in wafer transport containers that indirectly measures the particulate level in an empty container by flushing the container with a gas and counting particles flushed out.

An empirical correlation between the measured number of flushed particles and FM contamination of a test wafer(s) transported in the container is used to set a threshold limit on the number of flushed particles that may be tolerated before the container is cleaned. If the number of flushed particles (or the measure of contamination) is less than an acceptance threshold, the wafer contains the processing sequence. If the number is greater than a rejection threshold, the FOUP is sent out for cleaning and the wafer is either scrapped or salvaged. If the number is between these two values, the FOUP may be purged with a low-contamination gas.

A feature of the invention is that it can be fitted in existing operations in a manufacturing line, reducing the impact to the productivity of the line. The routine wafer rotation mentioned occurs at an equipment known as a wafer mapper/sorter—a simple piece of equipment that simply moves wafers from one FOUP to another in a controlled environment. A retrofit to the existing design would allow the FOUP inspection to occur in line and at the point just before the wafers were transferred into it.

Another feature of the invention is that the use of a test gas (N2 or CDA) will allow the FOUP to continue processing (have wafers transferred to it) with no elaborate drying or recovery procedure. Gas flow can also be readily inspected for particle size and counts which will determine the quality of the FOUP. The measurements taken will decide whether the FOUP will be: (1) Used—i.e. load wafers into it and proceed with the relevant processing sequence—when the contamination is within pre-determined specifications; (2) Removed from the mapper/sorter and sent for a thorough clean—when the contamination is well outside of specifications; or (3) Purged using the gas flow of the invention to bring the level of contamination down—when the fail was marginal.

Another feature of the invention is that FM contamination can be avoided by purging with the gas flow.

Another feature of the invention is that it can optionally include a gas flow manifold that provides for the optimization of gas flow through the FOUP to ensure that an accurate assessment of the contamination is given.

### BRIEF DESCRIPTION OF THE DRAWINGS

FIG. 1 shows a FOUP (100) loaded onto the port of a mapper/sorter together with a FOUP door and a test cover for use in the invention.

FIG. 2 shows a top view of the FOUP (100) with the Inspection system in place sealed to the FOUP

FIGS. 3A and 3B show top and side views of a FOUP with a test cover attached.

FIG. 4 shows a high level block diagram of a tool incorporating the invention.

FIG. 5 shows a block diagram of a portion of the tool of FIG. 4.

### DETAILED DESCRIPTION

A method of checking when a FOUP is contaminated according to the invention is an in-situ test for the residual contamination in the FOUP.

According to the invention, an in-situ test for residual contamination comprises flushing the FOUP with a gas such as nitrogen for a short time and measuring the number of particles that emerge.

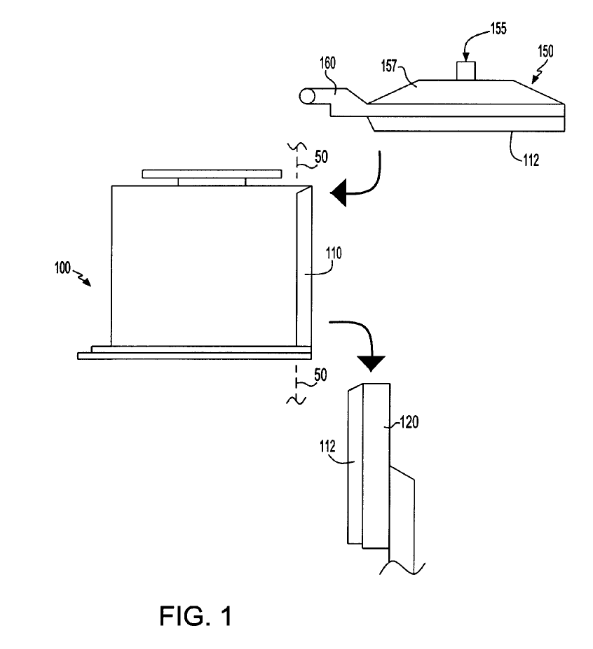

FIG. 1 shows a FOUP (100) loaded onto the port of a mapper/sorter (denoted schematically by dashed lines 50, with the FOUP enclosure's door (120) having been removed by the mapper/sorter's FOUP door opener and shown displaced and to the lower right of the Figure. This step exposes the internal surface of the FOUP to the mapper/sorter's internal environment. Once the FOUP door and door opener are clear of the FOUP opening, the face plate (112A) of the test cover 150 that is part of the Inspection System swings into place and seals against the FOUP door seal (110). The test cover is shown in the Figure as displaced from the FOUP and to the upper right of the Figure. The robotic handler that performs these actions is a conventional part of the mapper that is well known in the art.

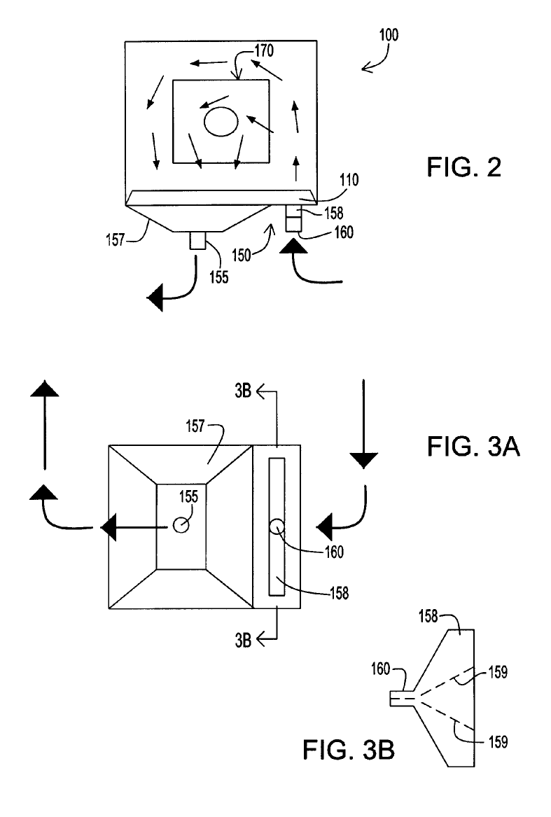

The flushing gas passes through the FOUP, entering on inlet 160 of the test cover, circulating within the FOUP as indicated by the arrows 170 shown in the top view of FIG. 2, and exiting on fitting 155 of the test cover.

Referring now to FIG. 5, showing a block/schematic diagram of components of a fab tool that perform the test steps, the flushing gas source is block 254, part of the fab gas supply that provides a very clean gas that is routinely tested to have a known reference level of particulate contamination that is very low. The exiting gas passes through an analyzer 256, that contains a conventional in-line particle detector such as Lasair Model 110 which has been utilized to evaluate the level of contamination of the ultra-pure environment found on the inside of process equipment in which exposed wafers are handled. This or a similar system can be dedicated/retrofitted directly in the fab tool and connected a computer in the Inspection System for sample analysis in the invention.

Subtracting the number of entering particles during the flush cycle from the number of particles exiting during the flush cycle gives the number of particles added to the test gas during its passage through the FOUP, which is a measure of the residual contamination in that particular FOUP.

Block 254 of FIG. 5 indicates a portion of the gas supply that feeds test gas with a known contamination into the FOUP during the test.

Block 256 indicates the measuring system that measures the number of contaminating particles exiting the FOUP during the test.

Preferably, the test gas flushes the FOUP for a fixed test period, e.g. 20 seconds, determined empirically to provide satisfactory statistics on the FOUP residual contamination.

Block 252 indicates the robot handler that removes from and re-inserts the FOUP door during production. In the course of the test according to the invention, the handler will insert the test cover in the standard interface in the FOUP, replacing the FOUP door.

Block 260 indicates a storage area in the tool that holds the test cover between tests.

Block 270, labeled control, represents a local control system that directs the other components to perform the test. Line 272 represents a link to a fab control system that directs the overall fab operation.

A connection between the residual contamination and the state of wafers transported in the FOUP is provided by placing one or more wafer(s) that has just been measured for FM contamination in the FOUP, passing the FOUP around the fab, entering the various machines that are used in the particular recipe that is being followed for that type of chip, and being carried between machines. At the end of the passage, the wafer is measured again for FM contamination and the net number of particles added during the trip through the fab is computed.

Repetition of this process for FOUPs with different levels of residual contamination gives a correlation between an average number of added particles in a trip around the fab and the measured residual contamination in the FOUP.

The process engineers in the fab have already made judgments as to the tolerable number of added particles, so that the test results will permit a decision on the tolerable residual contamination. FOUPs exceeding the tolerable amount will be sent out for cleaning. The tolerable number of added particles will depend on a tradeoff between yield improvement and cost and will change in time.

The result of the inspection process according to the invention is a criterion for either utilizing the FOUP, cleaning the FOUP, or purging the FOUP, based on the effect of contamination on yield that has not previously been available and a testing procedure based on empirical data.

FIGS. 2 and 3 illustrate in more detail a FOUP cover 150 according to the invention, in which standard interface 110 mates with the corresponding structure in the mapper. In contrast to the flat surface of the conventional FOUP door, the cover has a trapezoidal structure 157 occupying most of the surface to collect the exhaust gas efficiently and direct it to the exhaust port 155. The inlet port 160 also has a shaped structure 158 (shown in more detail in FIG. 3B) to provide space for the input gas to spread vertically.

FIG. 2 shows a top view of the FOUP (100) with the Inspection system in place sealed to the FOUP at the interface between the FOUP and seal (110). A gas flow (non-reactive such as CDA or N2) is introduced at the inlet port (160) and dispersed through the gas inlet manifold (158) which also allows for the gas flow to be optimized. The gas will flow through the FOUP at a pre-optimized flow pattern (170) and exit the FOUP at the collection manifold (157), leaving the face plate of the Inspection System through the outlet port (155).

FIG. 3A shows the layout of the face plate of the Inspection System and how the gas inlet and outlet may be laid out to interface with the FOUP's internal environment. The entire height of the FOUP will be inspected so it would be important that the interface cover the entire FOUP, allowing for optimal gas flow through the entire body of the FOUP.

Those skilled in the art will appreciate that a uniform flow of test gas, denoted with arrows 170 in FIG. 2, will pick up the residual contamination more efficiently than a flow that is confined vertically. Optionally, as shown in FIG. 3B, inlet port 160 may be spread among two or more nozzles or deflectors, e.g. top, bottom and center, to start out with a more uniform flow. Dotted lines 159 in FIG. 3B indicate flow direction control, which may be nozzles, deflection vanes or similar devices.

The analyzer attached to outlet 155 (in FIG. 3) is preferably followed by a vacuum pump, also denoted schematically by block 245, to aid in maintaining the gas flow.

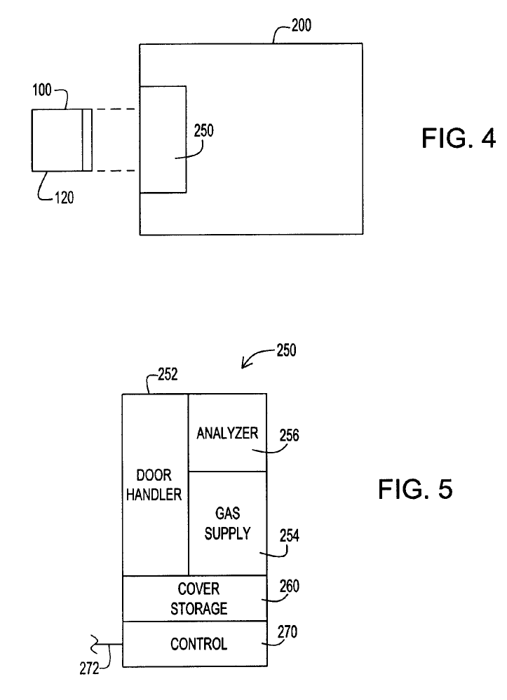

FIG. 4 shows a high-level view of the mapper/sorter 200 and how the components of the Inspection System may be included on board. FOUP 100 is shown displaced from tool 200. Block 250 devotes the contents of FIG. 5. The calculations referred to above may be calculated by a local CPU that calculates the contamination level of the FOUP and feeds back the data to the Main Material Management System in the fab as to the disposition of the FOUP, with the 3 options described above. The CPU (contained in the block in FIG. 5 labeled “CONTROL”) will contain a sampling collection system 256 to analyze the gas sample, and a local processor that will determine the status of the FOUP. If the FOUP can be purged locally with the gas flow, then the CPU will control the flow of gas.

The test process may be summarized as:

a) load an empty FOUP in a tool;

b) remove the FOUP door and store it;

c) Insert the test cover;

d) Feed test gas into the FOUP for a fixed time;

e) analyze the exhaust gas exiting the FOUP;

f) remove the test cover; and

g) replace the FOUP door;

For calibration, there will be additional steps of loading a premeasured wafer into the FOUP, transporting the FOUP around a standard route through the fab, and measuring the FM of the wafer.

During production, a test method according to the invention may be inserted as described above. In that case, a FOUP that has passed the test will be loaded with production wafers and continue to the next step in the process sequence.

The test may be performed in the mapper or at any other convenient point in the sequence of operations performed on the wafer. More than one test may be performed during the wafer's trip through the fab.

While the invention has been described in terms of a single preferred embodiment, those skilled in the art will recognize that the invention can be practiced in various versions within the spirit and scope of the following claims.

What is claimed is:

1. A method of measuring residual particulate contamination in a wafer carrier having a removable carrier door, comprising the steps of:
inserting the wafer carrier in a low contamination environment;
removing the carrier door;
inserting a test cover having a gas inlet and a gas outlet in the carrier in place of the carrier door;
flushing test gas having a known level of contaminant particles through the carrier; and
measuring the number of contaminant particles in the test gas exiting the carrier during the flushing, whereby the number of added particles added to the test gas during the passage through the carrier is a measure of the residual particle contamination of the carrier.

2. A method according to claim 1, comprising a step of inserting said carrier in a standard interface.

3. A method according to claim 1, comprising a step of directing a flow of gas within said carrier to increase the uniformity of the flow within the carrier.

4. A method according to claim 2, comprising a step of directing a flow of gas within said carrier to increase the uniformity of the flow within the carrier.

5. A method according to claim 1, in which said step of measuring is followed by one of:
a) loading wafers in said wafer carrier and continuing with a sequence of processing steps if said numbers of measured particles exiting the carrier is less than an acceptance threshold;
b) purging the carrier by flushing the test gas for a purge time if said number of measured particles exiting the carrier is greater than an acceptance threshold and less than a rejection threshold; or
c) cleaning said wafer carrier if the number of measured particles exiting the carrier is greater than said rejection threshold.

6. A method according to claim 2, in which said step of measuring is followed by one of:
a) loading wafers in said wafer carrier and continuing with a sequence of processing steps if said numbers of measured particles exiting the carrier is less than an acceptance threshold;
b) purging the carrier by flushing the test gas for a purge time if said number of measured particles exiting the carrier is greater than an acceptance threshold and less than a rejection threshold; or
c) cleaning said wafer carrier if the number of measured particles exiting the carrier is greater than said rejection threshold.

7. A method according to claim 3, in which said step of measuring is followed by one of:
a) loading wafers in said wafer carrier and continuing with a sequence of processing steps if said numbers of measured particles exiting the carrier is less than an acceptance threshold;
b) purging the carrier by flushing the test gas for a purge time if said number of measured particles exiting the carrier is greater than an acceptance threshold and less than a rejection threshold; or
c) cleaning said wafer carrier if the number of measured particles exiting the carrier is greater than said rejection threshold.

8. A method according to claim 4, in which said step of measuring is followed by one of:
a) loading wafers in said wafer carrier and continuing with a sequence of processing steps if said numbers of measured particles exiting the carrier is less than an acceptance threshold;
b) purging the carrier by flushing the test gas for a purge time if said number of measured particles exiting the carrier is greater than an acceptance threshold and less than a rejection threshold; or
c) cleaning said wafer carrier if the number of measured particles exiting the carrier is greater than said rejection threshold.

9. An apparatus for measuring residual particulate contamination in a wafer carrier having a removable carrier door with a standard interface, comprising:
an enclosure having a matching interface to said standard interface that mates with said standard interface, the enclosure having a low contamination environment;
a controllable robotic material handler for removing said carrier door and replacing said carrier door in said matching interface with a test cover having a gas inlet and a gas outlet;
gas flushing means connected to said gas inlet for flushing a test gas having a known level of contaminant particles through the carrier in a flush cycle; and
analyzer means connected to said gas outlet for measuring the number of contaminant particles in the test gas exiting the carrier during the flush cycle, whereby the number of added particles added to the test gas during the passage through the carrier is a measure of the residual particle contamination of the carrier.

10. An apparatus according to claim 9, further comprising gas direction means in said test cover for increasing the uniformity of gas from through said carrier.

11. An apparatus according to claim 9, further comprising local control means for controlling said flush cycle and for controlling a purge cycle when said residual contamination is within a purge range.

12. An apparatus according to claim 10, further comprising local control means for controlling said flush cycle and for controlling a purge cycle when said residual contamination is within a purge range.

13. A method of processing an integrated circuit formed in a semiconductor substrate transported in a wafer carrier having a removable carrier door, comprising the steps of:
a) inserting the wafer carrier in a low contamination environment;
b) removing the carrier door;
c) inserting a test cover having a gas inlet and a gas outlet in the carrier in place of the carrier door;
d) flushing test gas having a known level of contaminant particles through the carrier;
e) measuring the number of contaminant particles in the test gas exiting the carrier during the flushing, whereby the number of added particles added to the test gas during the passage through the carrier is a measure of the residual particle contamination of the carrier; and
comparing the residual particle contamination with a criterion.

14. A method according to claim 13, comprising a step of inserting said carrier in a standard interface.

15. A method according to claim 13, comprising a step of directing a flow of gas within said carrier to increase the uniformity of the flow within the carrier.

16. A method according to claim 14, comprising a step of directing a flow of gas within said carrier to increase the uniformity of the flow within the carrier.

17. A method according to claim 13, further comprising the steps of repeating steps a) through e) at least once in the process of adding a layer to said integrated circuit in a passage through a fabrication facility.

18. A method according to claim 14, further comprising the steps of repeating steps a) through e) at least once in the process of adding a layer to said integrated circuit in a passage through a fabrication facility.

19. A method according to claim 16, further comprising the steps of repeating steps a) through e) at least once in the process of adding a layer to said integrated circuit in a passage through a fabrication facility.
